(19) United States
(12) Patent Application Publication
(10) Pub. No.: US 2017/0219962 A1
(43) Pub. Date: Aug. 3, 2017

(54) SEAL MEMBER, UNIT, AND IMAGE FORMING APPARATUS

(71) Applicant: CANON KABUSHIKI KAISHA, Tokyo (JP)

(72) Inventors: Hiraku Sasaki, Susono-shi (JP); Hiroomi Matsuzaki, Mishima-shi (JP); Kazuki Matsumoto, Fuji-shi (JP)

(21) Appl. No.: 15/407,324

(22) Filed: Jan. 17, 2017

(30) Foreign Application Priority Data
Jan. 29, 2016 (JP) 2016-014998

(51) Int. Cl. G03G 15/08

(52) U.S. Cl. CPC G03G 15/0898

(57) ABSTRACT

A seal member 14 which seals a gap among a rotating body 9 provided in an opening of a frame body 13, a blade 18a, and the frame body 13 in an end region in an axial direction of the rotating body 9, the seal member 14 including: a first seal portion 14b which comes into contact with the rotating body 9; a second seal portion 14e which comes into contact with the blade 18a; and a third seal portion 14f which is constituted by a surface formed in a stair shape and sequentially arranged between the first seal portion 14b and the second seal portion 14e and which is capable of reducing a gap formed between the rotating body 9 and the blade 18a due to rotation of the rotating body 9.

### BACKGROUND OF THE INVENTION

Field of the Invention

The present invention relates to a seal member in an image forming apparatus and in a process cartridge.

Description of the Related Art

Units such as a developing apparatus and a process cartridge which constitute an electrophotographic image forming apparatus (hereinafter, an image forming apparatus) are configured such that a cleaning blade, a developing blade, and the like are brought into contact with a rotating body such as a photosensitive drum and a developing roller. With such units, in order to prevent a developer from leaking, a seal member is provided at ends in an axial direction of a rotary shaft of a photosensitive drum, a developing roller, and the like. Seal members using an elastic body such as an elastomer are known as such seal members (for example, refer to Japanese Patent Application Laid-open No. H04-243277 and Japanese Patent Application Laid-open No. H07-013390).

### SUMMARY OF THE INVENTION

Usually, when providing a rotating body with a seal member and causing the seal member to exhibit seal performance, an abutment portion shape of the seal member may be determined so as to follow an external shape of the rotating body. However, when desiring seal performance to be exhibited with respect to a blade in addition to the rotating body, the abutment portion shape of the seal member must be determined so as to follow not only the external shape of the rotating body but also a shape of the blade. In other words, sufficient seal performance must be exhibited when in sliding contact with the rotating body which is a rotating member and, at the same time, sufficient seal performance must be exhibited when in contact with the blade which is a fixed member. In addition, since a fine movement of the blade may occur due to sliding relative to the rotating body even though the blade is fixed to a frame body, the seal member must also have followability with respect to such state changes. As described above, producing perfect seal performance with respect to two members with different properties as seal objects is no easy task. In particular, since it is difficult to arrange the seal member all the way to a corner portion of a stepped portion formed by a blade tip and the rotating body, sufficient seal performance may not always be exhibited.

A seal configuration disclosed in Japanese Patent Application Laid-open No. H04-243277 only assumes sealing between a rotating body and a frame body and does not consider a blade as a seal object. Therefore, with a seal member disclosed in Japanese Patent Application Laid-open No. H04-243277, while seal performance can be expected with respect to a rotating body, there is a possibility that seal performance cannot be exhibited with respect to a stepped portion formed by the blade tip and the rotating body described above. In addition, while a seal configuration disclosed in Japanese Patent Application Laid-open No. H07-013390 exhibits seal performance with respect to both a rotating body and a blade, a component specifically targeting the stepped portion described above is not provided. Therefore, with a seal member disclosed in Japanese Patent Application Laid-open No. H07-013390, there is a possibility that sufficient seal performance cannot be exhibited with respect to the stepped portion and particularly all the way to a corner portion thereof.

An object of the present invention is to provide a technique enabling an occurrence of a gap that causes leakage of a developer in a developer housing portion to be more effectively suppressed.

In order to achieve the object described above, a seal member according to an embodiment of the present invention is a seal member formed of an elastic body and used in a unit or an image forming apparatus including a frame body which is provided with a housing portion for housing a developer, a rotating body which is provided in an opening of the housing portion of the frame body, and a blade which comes into contact with a surface of the rotating body,

the seal member being provided on the frame body in order to prevent the developer from leaking out from a gap among the frame body, the rotating body, and the blade in an end region of the opening in an axial direction of a rotary shaft of the rotating body, the seal member comprising:

a first seal portion which comes into contact with the rotating body;

a second seal portion which comes into contact with the blade; and

a third seal portion which is constituted by a surface formed in a stair shape and sequentially arranged between the first seal portion and the second seal portion and which causes a gap formed between the rotating body and the blade to decrease due to rotation of the rotating body.

In order to achieve the object described above, a seal member according to an embodiment of the present invention is a seal member formed of an elastic body and used in a unit or an image forming apparatus including a frame body which is provided with a housing portion for housing a developer, a rotating body which is provided in an opening of the housing portion of the frame body, and a blade which comes into contact with a surface of the rotating body,

the seal member being provided on the frame body in order to prevent the developer from leaking out from a gap among the frame body, the rotating body, and the blade in an end region of the opening in an axial direction of a rotary shaft of the rotating body, the seal member comprising:

a first seal portion which comes into contact with the rotating body;

a second seal portion which comes into contact with the blade; and

a third seal portion which comes into contact with (i) an end surface, disposed in a tip portion of the blade, with which the second contact portion does not come into contact and (ii) a region, disposed in a surface of the rotating body adjacent to the end surface, with which the first seal portion does not come into contact, wherein the third seal portion is capable of assuming:

a first state where the third seal portion has a gap in relation to the rotating body and the blade, the gap being such that a distance between the third seal portion and the tip surface broadens gradually in a rotation direction of the rotating body towards the region on the surface of the rotating body; and

a second state where the gap has been narrowed or the gap has been filled.

In order to achieve the object described above, a unit according to an embodiment of the present invention is a unit attachable to and detachable from an apparatus main body of an image forming apparatus, the unit comprising:

a frame body which is provided with a housing portion for housing a developer;

a rotating body which is provided in an opening of the housing portion of the frame body;

a blade which comes into contact with a surface of the rotating body; and

the seal member.

In order to achieve the object described above, an image forming apparatus according to an embodiment of the present invention is an image forming apparatus, comprising:

a frame body which is provided with a housing portion for housing a developer;

a rotating body which is provided in an opening of the housing portion of the frame body;

a blade which comes into contact with a surface of the rotating body so as to restrict an amount of the developer, borne by the rotating body, which is carried outside through the opening; and

the seal member.

According to the present invention, an occurrence of a gap that causes leakage of a developer in a developer housing portion can be more effectively suppressed.

Further features of the present invention will become apparent from the following description of exemplary embodiments with reference to the attached drawings.

### BRIEF DESCRIPTION OF THE DRAWINGS

FIGS. 1A to 1D are schematic diagrams of a process cartridge in which a seal member according to a first embodiment of the present invention is arranged;

FIG. 2 is a schematic sectional view of an image forming apparatus according to an embodiment of the present invention;

FIG. 3 is a schematic sectional view of a process cartridge according to an embodiment of the present invention;

FIG. 4 is a schematic diagram of a process cartridge in which a seal member according to the first embodiment of the present invention is arranged;

FIGS. 5A to 5C are schematic diagrams of a process cartridge in which a seal member according to the first embodiment of the present invention is arranged;

FIGS. 6A to 6C are schematic diagrams of a process cartridge in which a seal member according to a second embodiment of the present invention is arranged;

FIGS. 7A to 7D are schematic diagrams of a process cartridge in which a seal member according to the second embodiment of the present invention is arranged;

FIG. 8 is a schematic diagram of a process cartridge in which a seal member according to the second embodiment of the present invention is arranged;

FIGS. 9A to 9C are schematic diagrams of a process cartridge in which a seal member according to a third embodiment of the present invention is arranged;

FIGS. 10A to 10D are schematic diagrams of a process cartridge in which a seal member according to the third embodiment of the present invention is arranged; and

FIGS. 11A and 11B are schematic diagrams of a process cartridge in which a seal member according to the third embodiment of the present invention is arranged.

### DESCRIPTION OF THE EMBODIMENTS

Modes for carrying out the present invention are illustratively explained in detail below on the basis of embodiment with reference to the drawings. However, dimensions, materials, and shapes of components described in the embodiments, relative arrangement of the components, and the like should be changed as appropriate according to the configuration of an apparatus to which the invention is applied and various conditions. That is, the dimensions, the materials, the shapes, and the relative arrangement are not intended to limit the scope of the present invention to the embodiments.

### First Embodiment

The present invention relates to a developing apparatus, a developing cartridge, and a process cartridge, and to an image forming apparatus using these components. A developing apparatus refers to an apparatus which includes a developing roller (a developer bearing member) that bears a developer on a surface thereof and which uses the developer to convert an electrostatic latent image (an electrostatic image) formed on a photosensitive drum (an image bearing member) by the developing roller into a visible image. A developing cartridge is the developing apparatus made into a cartridge as an integrated unit and is attachably and detachably mounted to an image forming apparatus main body. In addition, a process cartridge refers to a cartridge made up of a photosensitive drum and a developing apparatus that acts on the photosensitive drum as an integrated unit and is attachably and detachably mounted to an image forming apparatus main body. Furthermore, an image forming apparatus refers to an apparatus that forms an image on a recording medium (a recording material) such as a sheet material using an electrophotographic image forming system.

Examples of an electrophotographic image forming apparatus include an electrophotographic copier, an electrophotographic printer (such as an LED printer and a laser beam printer), a facsimile device, and a word processor.

(Overall Configuration of Image Forming Apparatus)

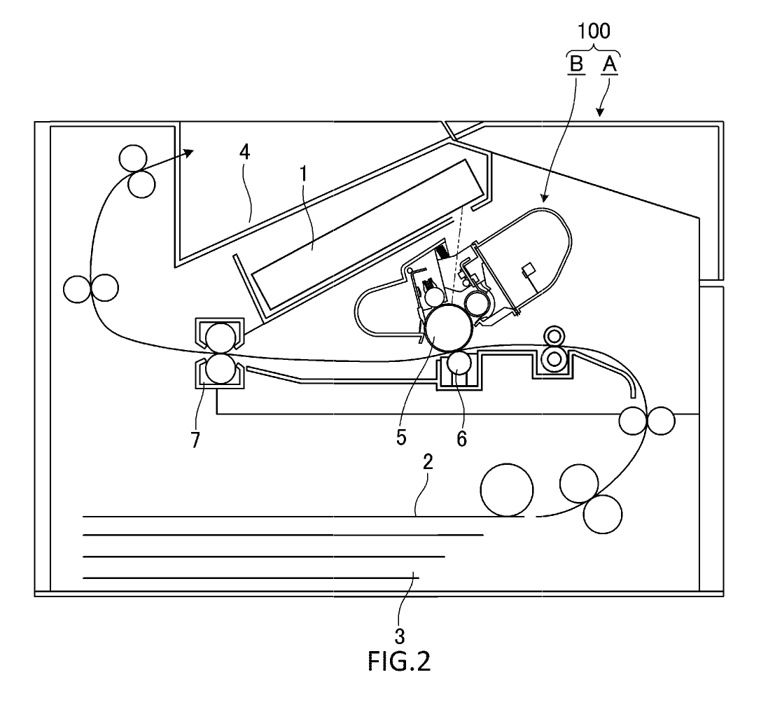

FIG. 2 is a schematic sectional view showing a configuration of an image forming apparatus 100 according to the present embodiment in a state where a process cartridge B is mounted to an image forming apparatus main body A (hereinafter, an apparatus main body A). With the image forming apparatus 100, exposing means 1 irradiates information light (laser light, LED light, or the like) based on image information on a photosensitive drum 5 which is an electrophotographic photoreceptor, and a developer image is formed by causing a developer to adhere to the latent image. At this point, a recording material 2 is conveyed from a recording material supply portion 3 in synchronization with the formation of the developer image, and the developer image formed on the photosensitive drum 5 is transferred onto the recording material 2 by applying a transfer bias to a transfer roller 6 which is transfer means. Subsequently, after fixing the image transferred onto the recording material 2 by fixing means 7, the recording material 2 is discharged to a recording material discharge portion 4. In this case, the apparatus main body A refers to a constituent portion excluding the cartridge B in an apparatus configuration of the image forming apparatus 100.

(Configuration of Process Cartridge)

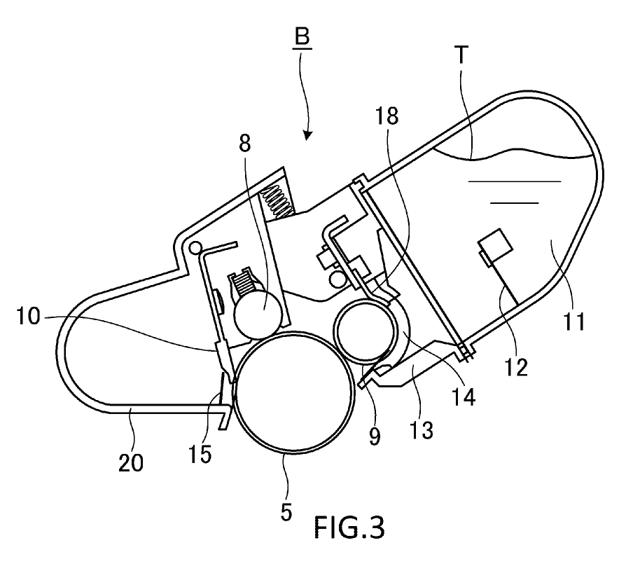

FIG. 3 is a sectional view showing a configuration of the process cartridge B. The process cartridge B includes the photosensitive drum 5 and at least one processing means which acts on the photosensitive drum 5, and is attachable to and detachable from the apparatus main body A. Processing means include charging means which charges the photosensitive drum 5, developing means which develops the latent image on the photosensitive drum 5, and cleaning means which cleans the developer remaining on the photosensitive drum 5. The process cartridge B according to the present embodiment includes a charging roller 8 as charging means and a cleaning blade 10 as cleaning means . In addition, the process cartridge B includes a developing roller (developer bearing member) 9, a developing blade 18, and the like as developing means.

Furthermore, the process cartridge B includes a developer housing portion 11 which houses a developer T. In the developer housing portion 11, a stirring member 12 for stirring and conveying the developer T is rotatably provided in a housing space of the developer T. A developing frame body 13 is integrally coupled to the developer housing portion 11, and the developing roller 9 is rotatably supported by a bearing (not shown) on the developing frame body 13. Roughly speaking, the process cartridge B is configured so as to unite a cleaning unit and a developing unit. The cleaning unit is constituted by the photosensitive drum 5, a drum frame body 20, the charging roller 8, the cleaning blade 10, and the like. Meanwhile, the developing unit is constituted by a developer container made up of the developer housing portion 11 and the developing frame body 13, a developing blade 18, the developing roller 9, the stirring member 12, a toner T, and the like.

The developer T housed in the developer housing portion 11 passes through an opening provided on the developing frame body 13 and adheres to and is borne on a surface of the developing roller 9. The developing frame body 13 is a member which constitutes a frame body of a developer container in the developing apparatus together with a frame body which constitutes the developer housing portion 11 and is a member which forms an opening of the frame body of the developer container. The developing roller 9 is rotatably provided in the opening. The developer T is supplied to the surface of the developing roller 9 from inside the developer housing portion 11 via the opening provided on the developing frame body 13, and is carried on the rotating developing roller 9 to the outside. The developer adhered to the developing roller 9 passes through the opening of the developing frame body 13 and is carried outside while being subjected to restrictions in an amount of adherence to the surface of the developing roller 9 by the developing blade 18 as a developer layer thickness restricting member. In order to prevent the developer T from leaking to the outside from between the opening of the developing frame body 13 and the developing roller 9 with the exception of being conveyed by the surface of the developing roller 9, a seal member 14 is provided at both ends in an axial direction of a rotary shaft of the developing roller 9. The seal member 14 seals a gap between the opening of the developing frame body 13 and the developing roller 9 and the developing blade 18 in a peripheral region of an end in the axial direction of the rotary shaft of the developing roller 9 so that the developer T does not leak out.

In addition, the photosensitive drum 5 is rotatably supported to a drum frame body 20 by a bearing (not shown). Furthermore, a seal member 15 is provided at both ends in an axial direction of the photosensitive drum 5 so that the developer does not leak out from between the photosensitive drum 5 and the drum frame body 20. While the seal member 14 provided at both ends of the developing roller 9 will be hereinafter described as a seal member to which the present invention is applied, the present invention is also applicable to other similar components such as the seal member 15 provided at both ends of the photosensitive drum 5. In this case, the developing frame body 13 is replaced by the drum frame body 20, the developing roller 9 is replaced by the photosensitive drum 5, and the developing blade 18 is replaced by the cleaning blade 10.

(Configuration of Seal Member)

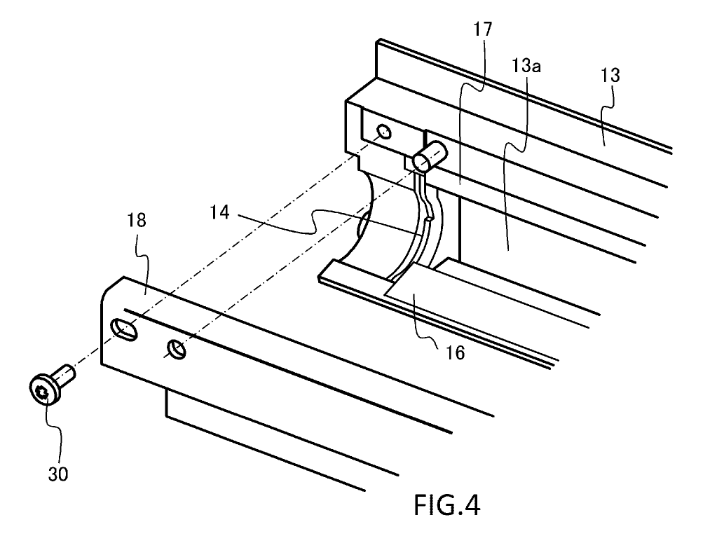

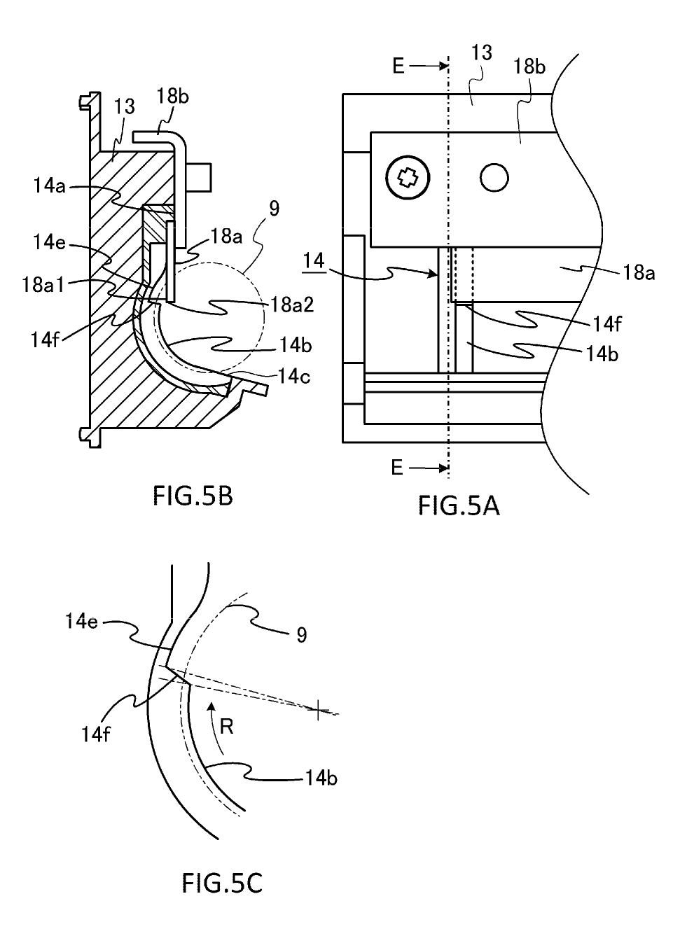

A configuration of a seal member according to the present embodiment will be described with reference to FIGS. 4 to 5C. FIG. 4 is a schematic exploded perspective view showing a periphery of the seal member 14 when attaching the developing blade 18 of the process cartridge B according to the present embodiment. FIGS. 5A to 5C are schematic diagrams showing a state where the developing blade 18 has been attached to the developing frame body 13. Since the developing roller 9 has not yet been mounted, the developing roller 9 is represented in the drawing by a two dot chain line arc. FIG. 5A is a view of the developing frame body 13 from a side of a position where the developing roller 9 is to be attached. FIG. 5B is a sectional view taken along E-E in FIG. 5A (the developing roller 9 is not shown in FIG. 5A). FIG. 5C is an enlarged view of a stepped portion 14f to be described later. In FIG. 5C, R represents a direction in which the developing roller 9 rotates.

The developing frame body 13 has an opening 13a for receiving the developer T conveyed from the developer housing portion 11 and for guiding the developer T to the surface of the developing roller 9. In addition, a longitudinal seal member 16, the seal member 14, and a blade seal member 17 are provided so as to surround the opening 13a. The developing blade 18 is constituted by a blade 18a made of polyurethane rubber as a blade portion and a metallic blade supporting plate 18b as a blade portion supporting portion, and is fixed to the developing frame body 13 by a screw 30. The longitudinal seal member 16 seals between the developing frame body 13 and the developing roller 9 over an approximately entire region in a longitudinal direction of the developing roller 9, and the blade seal member 17 seals between the developing frame body 13 and the developing blade 18 over an approximately entire region in a longitudinal direction of the developing blade 18. In addition, the seal member 14 comes into contact with the longitudinal seal member 16, the blade seal member 17, the blade 18a, and the developing roller 9 to prevent leaking of the developer from a contact portion with each member at both end regions in the longitudinal direction of the developing roller 9 (the developing blade 18).

The seal member 14 according to the present embodiment is formed of an elastic body (a rubber-like elastic body) such as an elastomer resin or rubber and is attached to the developing frame body 13. A method of attaching the seal member 14 to the developing frame body 13 is not particularly limited and the seal member 14 may be bonded by an adhesive or the like or may be integrally molded to the developing frame body 13. Roughly speaking, the seal member 14 is formed on a surface opposing a peripheral surface of the developing roller 9 on the developing frame body 13 and is configured to protrude toward and come into contact with the peripheral surface of the developing roller 9 from the opposing surface. The seal member 14 sequentially has shapes such as a supporting plate contact portion 14a which comes into contact with the blade supporting plate 18b, a blade contact portion 14e which comes into contact with the blade 18a, a rotating body contact portion 14b which comes into contact with the developing roller 9, and a longitudinal seal contact portion 14c which comes into contact with the longitudinal seal member 16. The rotating body contact portion 14b as a first seal portion is formed by an arc portion which is concentric with the rotary shaft of the developing roller 9 and which has a smaller diameter than the developing roller 9. The blade contact portion 14e as a second seal portion also has an arc portion which is concentric with the developing roller 9 in a similar manner to the rotating body contact portion 14b. The arc portion has a diameter that is larger than that of the rotating body contact portion 14b by a distance equal to or less than a thickness of the blade 18a. The blade contact portion 14e is constituted by a first portion which closely adheres to the blade 18a before assembly of the developing roller 9 and during assembly of the developing blade 18 (a portion in contact with the blade 18a in FIG. 5B) and a second portion which is a portion other than the first portion and which closely adheres to the blade 18a during assembly of the developing roller 9.

Furthermore, the seal member 14 includes a stepped portion 14f as a third seal portion that is a portion which comes into contact with a tip surface 18a2 of the blade 18a and which connects the rotating body contact portion 14b and the blade contact portion 14e with each other. As shown in FIG. 5C, the stepped portion 14f continues inclined from the blade contact portion 14e toward an upstream side in a rotation direction during image formation of the developing roller 9 and toward the rotating body contact portion (14b).

Specifically, the rotating body contact portion 14b includes an arc-shaped contact surface centered on the rotary shaft of the developing roller 9 as a first contact surface which comes into contact with the developing roller 9. In addition, as a second contact surface which comes into contact with the blade 18a, the blade contact portion 14e includes an arc-shaped contact surface which is centered on the rotary shaft of the developing roller 9 and of which a distance from the rotary shaft of the developing roller 9 is longer than that of the contact surface of the rotating body contact portion 14b. Furthermore, as a third contact surface, the stepped portion 14f includes a contact surface that is a surface which connects between the contact surface of the rotating body contact portion 14b and the contact surface of the blade contact portion 14e and which extends in a direction inclined with respect to a radial direction of an imaginary circle centered on the rotary shaft of the developing roller 9. The contact surface of the stepped portion 14f is a surface which, in a state before assembly of the developing roller 9 and the developing blade 18, extends in a direction inclined with respect to a direction in which the end surface 18a2 of the tip portion of the blade 18a extends when the developing roller 9 and the developing blade 18 are assembled to the developing frame body 13. The stepped portion 14f comes into contact with the end surface 18a2 of the tip portion of the blade 18a with which the blade contact portion 14e does not come into contact and a region which is a region of the surface of the developing roller 9 adjacent to the end surface 18a2 and with which the rotating body contact portion 14b does not come into contact. The respective seal portions of the rotating body contact portion 14b, the blade contact portion 14e, and the stepped portion 14f have a same width in a rotational axis direction of the developing roller 9, and the respective contact surfaces also have a same width in the same direction.

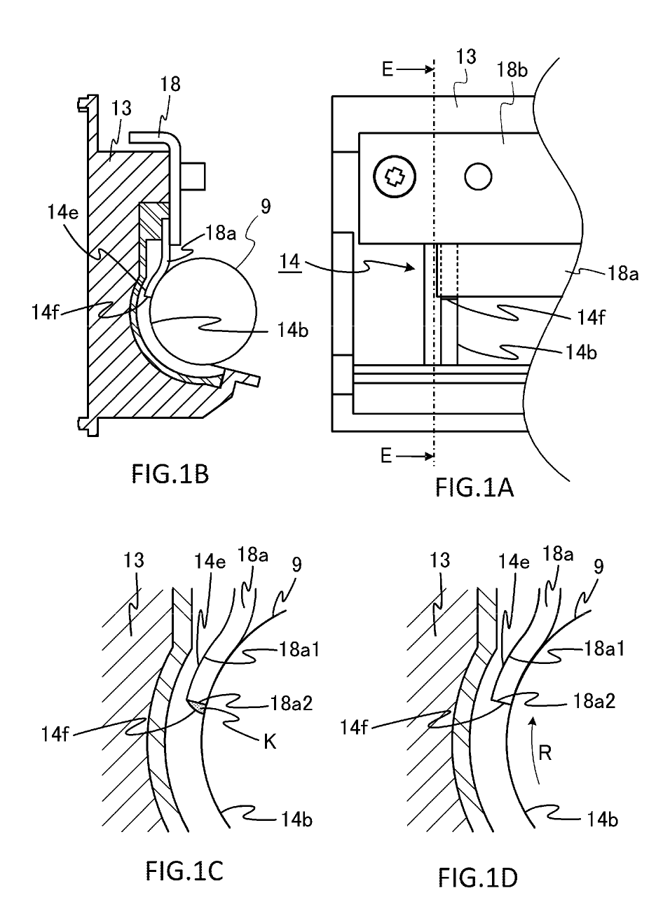

FIGS. 1A to 1D are diagrams explaining a state where the developing roller 9 is assembled with respect to the state shown in FIGS. 5A to 5C. FIG. 1A is a view of the developing frame body 13 seeing from a side of a position where the developing roller 9 is attached, in which the developing roller 9 has been omitted in order to facilitate understanding of the configuration. FIG. 1B is a sectional view cut along E-E in FIG. 1A. In addition, FIGS. 1C and 1D are enlarged views in the axial direction of the rotary shaft of the developing roller 9 of a periphery of a position where the developing roller 9, the seal member 14, and the blade 18a come into contact with one another. FIG. 1C shows a stationary state after the developing roller 9 is assembled and before the developing roller 9 is rotated or, in other words, a state where the developing roller 9 is stopped before rotating for the first time. FIG. 1D shows a rotating state of the developing roller 9 or, in other words, a state after the developing roller 9 has started rotating for the first time.

Assembly of the developing roller 9 causes the blade 18a and the rotating body contact portion 14b to deform so as to conform to an outer circumferential surface of the developing roller 9 and causes the rotating body contact portion 14b to be compressed in the radial direction by the developing roller 9. In addition, the deformation of the blade 18a causes the blade contact portion 14e to be compressed so as to conform to a surface 18a1 of the blade 18a on a side which does not come into contact with the developing roller 9. Accordingly, the rotating body contact portion 14b closely adheres to the developing roller 9 and the blade contact portion 14e closely adheres to the blade 18a. When the developing roller 9 is still in a stationary state immediately after assembly, the tip surface 18a2 of the blade 18a and the stepped portion 14f of the seal member 14 are either in a state of partial contact or in a completely noncontact state. At this point, a stepped gap K enclosed by the developing roller 9, the stepped portion 14f of the seal member 14, and the tip surface 18a2 of the blade 18a is created (FIG. 1C) . The stepped gap K is a gap in which a distance between the stepped portion 14f and the tip surface 18a2 of the blade 18a broadens in a rotation direction of the developing roller 9 towards the surface of the developing roller 9.

The reason for creating the stepped gap K will now be described. Normally, in order to prevent a developer from leaking, respective members must be arranged so as to adequately adhere to one another to fill the gaps between the members. Achieving this requires creating a state immediately after assembly of the developing roller 9 where such gaps are not created. However, in this case, a part of the seal member 14 may already be caught between the developing roller 9 and the blade 18a immediately after assembly of the developing roller 9 or may get caught between the developing roller 9 and the blade 18a when the developing roller 9 rotates in the rotation direction R during image formation and, consequently, there is a risk of a gap being created. In consideration thereof, in the present embodiment, a configuration is adopted in which a gap is created between the stepped portion 14f of the seal member 14 and the tip surface 18a2 of the blade 18a during assembly of the developing roller 9 in order to achieve both prevention of catching and seal performance.

A side near the rotating body contact portion 14b of the stepped portion 14f having a particularly high risk of getting caught is arranged more on an upstream side of the rotation direction of the developing roller 9 than a side near the blade contact portion 14e of the stepped portion 14f. Even in a case where the stepped gap K is created, when the developing roller 9 rotates in the rotation direction R as shown in FIG. 1D, the rotating body contact portion 14b also rotates and moves due to friction force, and the stepped portion 14f also moves following the rotation and movement of the rotating body contact portion 14b and closely adheres to the tip surface 18a2 to exhibit seal performance. In other words, as shown in FIG. 1C, before the developing roller 9 rotates for the first time, the stepped portion 14f is in a state where the stepped gap K is formed as a first state. In addition, the stepped portion 14f deforms as the developing roller 9 rotates for the first time and, as shown in FIG. 1D, enters a state where the stepped gap K is filled or a state where the stepped gap K is narrowed to such a degree that sufficient seal performance is exhibited as a second state. Specifically, surfaces formed in a stair pattern are sequentially formed as the stepped portion 14f between the rotating body contact portion 14b and the blade contact portion 14e and, due to rotation of the developing roller 9, a gap formed between the developing roller 9 and the developing blade 18 decreases. The deformation of the stepped portion 14f that is sequentially arranged between the rotating body contact portion 14b and the blade contact portion 14e is a deformation such that, while filling the stepped gap K or while narrowing the stepped gap K, a portion that is sandwiched between the developing roller 9 and the blade 18a is not created in the stepped portion 14f.

A size of the stepped gap K changes due to dimensional tolerance, assembly tolerance and so on of the seal member 14 and the blade 18a. However, by appropriately selecting an angle of inclination of the stepped portion 14f and/or a shape of the inclined portion (in addition to a straight line, a curved line or a combination thereof), the stepped portion 14f can be configured so as to move following the rotation of the developing roller 9 until closely adhering with the tip surface 18a2. Therefore, even if the size of the stepped gap K differs, seal performance can be exhibited. After rotation of the developing roller 9, since friction force between the developing roller 9 and the rotating body contact portion 14b enables the stepped portion 14f to maintain close adherence with the tip surface 18a2, seal performance is maintained without the stepped gap K created once again.

### Second Embodiment

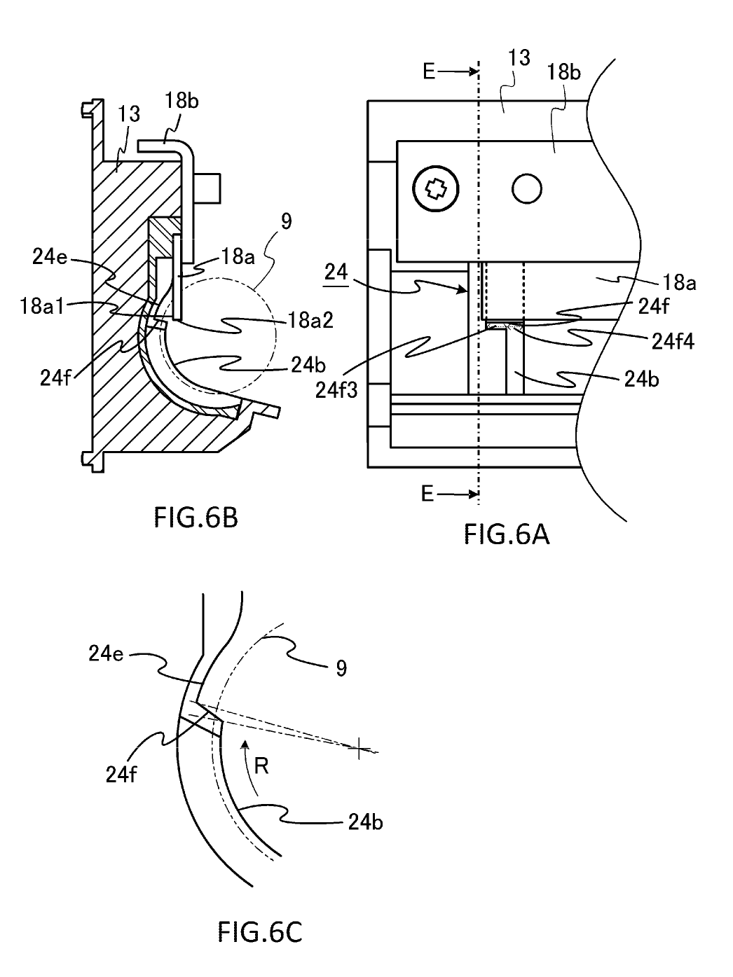

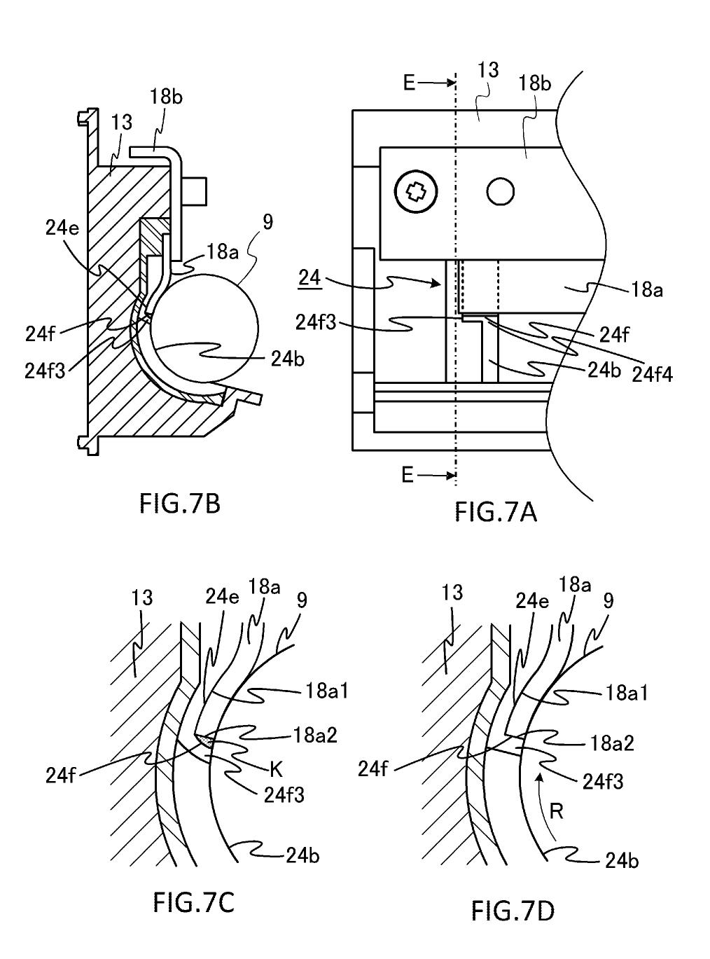

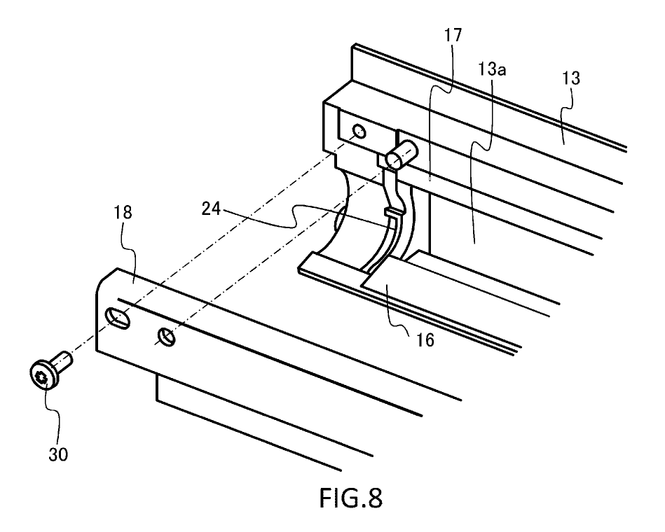

A configuration of a second embodiment of the present invention will now be described with reference to FIGS. 6A to 8. FIGS. 6A to 6C are diagrams showing the seal member 14 shown in FIGS. 5A to 5C being replaced by a seal member 24 according to the present embodiment. In a similar manner, FIGS. 7A to 7D are diagrams showing the seal member 14 shown in FIGS. 1A to 1D being replaced by the seal member 24, and FIG. 8 is a diagram showing the seal member 14 shown in FIG. 4 being replaced by the seal member 24. In the second embodiment, components in common with those of the first embodiment are assigned same reference characters and descriptions thereof will be omitted. Matters not described in the second embodiment are similar to those described in the first embodiment.

As shown in FIG. 6A, a stepped portion 24f of the seal member 24 according to the present embodiment has a shape that is more elongated in an outer side direction (a leftward direction in FIG. 6A) of the frame body 13 than a rotating body contact portion 24b along a longitudinal direction of the blade 18a. Specifically, the stepped portion 24f as a third seal portion includes a portion 24f4 (a coupled portion) that continues to the rotating body contact portion 24b as a first seal portion in a circumferential direction of the developing roller 9 and a portion (side end portion) 24f3 (a non-coupled portion) that does not continue to the rotating body contact portion 24b. Unlike a stepped portion 34f of a seal member 34 according to a third embodiment to be described later, the coupled portion and the non-coupled portion are integrally continuous in the axial direction of the developing roller 9 in the stepped portion 24f according to the present embodiment. Among widths of the respective seal portions in the axial direction of the developing roller 9, widths of a blade contact portion 24e as a second seal portion and the stepped portion 24f are the same, the rotating body contact portion 24b is shorter than the other two seal portions, and contact surfaces of the respective seal portions have a similar width relationship.

When the developing roller 9 is assembled, the blade 18a and the seal member 24 deform as shown in FIG. 7B. Accordingly, the rotating body contact portion 24b closely adheres to the developing roller 9 and the blade contact portion 24e closely adheres to the surface 18a1 of the blade 18a that does not come into contact with the developing roller 9. In addition, a configuration is adopted in a similar manner to the first embodiment such that, as shown in FIG. 7C, a stepped gap K enclosed by the developing roller 9, the stepped portion 24f of the seal member 24, and the tip surface 18a2 of the blade 18a is created. The fact that seal performance is exhibited as the stepped portion 24f closely adheres to the tip surface 18a2 following rotation of the developing roller 9 is also similar to the first embodiment.

In the second embodiment, a width of the stepped portion 24f in the axial direction of the developing roller 9 is configured so as to be wider than that of the rotating body contact portion 24b, which contrasts with the first embodiment in which both widths are the same. Specifically, the stepped portion 24f according to the present embodiment is configured so as to include the portion 24f4 (the coupled portion) that is supported by the rotating body contact portion 24b in the rotation direction of the developing roller 9 and the portion 24f3 (the non-coupled portion) that is not directly supported by the rotating body contact portion 24b. Accordingly, the stepped portion 24f according to the present embodiment is to include the portion 24f3 (the non-coupled portion) where deformation is likely to occur due to sliding with the developing roller 9 and the portion 24f4 (the coupled portion) where deformation is less likely to occur. Since the non-coupled portion 24f3 of the stepped portion 24f is formed separated from the rotating body contact portion 24b and is capable of moving flexibly, the non-coupled portion 24f3 more readily closely adheres to the tip surface 18a2 than the coupled portion 24f4 when the developing roller 9 rotates . In addition, a surface of the seal member 24 which comes into sliding contact with the rotating developing roller 9 is configured such that an area of the surface over the entire seal member 24 is relatively wider in the axial direction of the developing roller 9 in a stepped portion formed by the developing roller 9 and the developing blade 18 where leakage is particularly likely to occur. Accordingly, adherence and seal performance of the seal member 24 can be improved.

Moreover, while the stepped portion 24f according to the present embodiment is configured such that the non-coupled portion 24f3 is arranged on an outer side in the axial direction of the developing roller 9 relative to the coupled portion 24f4, the configuration of the stepped portion 24f is not limited thereto.

The non-coupled portion 24f3 may be arranged on an inner side in the axial direction of the developing roller 9 relative to the coupled portion 24f4 or the non-coupled portion 24f3 may be arranged on both sides of the coupled portion 24f4 in the axial direction.

### Third Embodiment

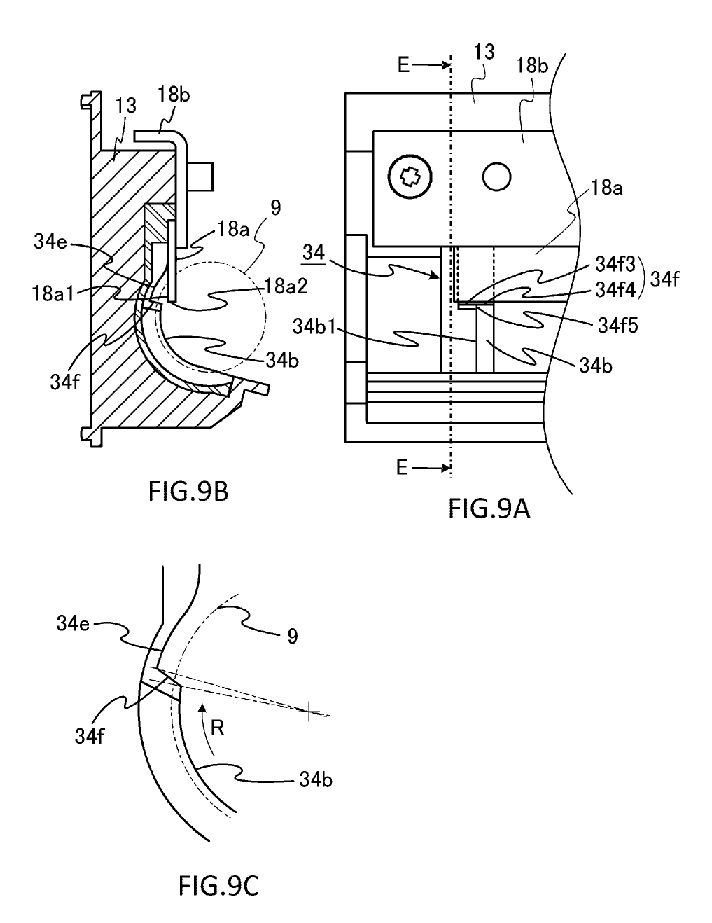

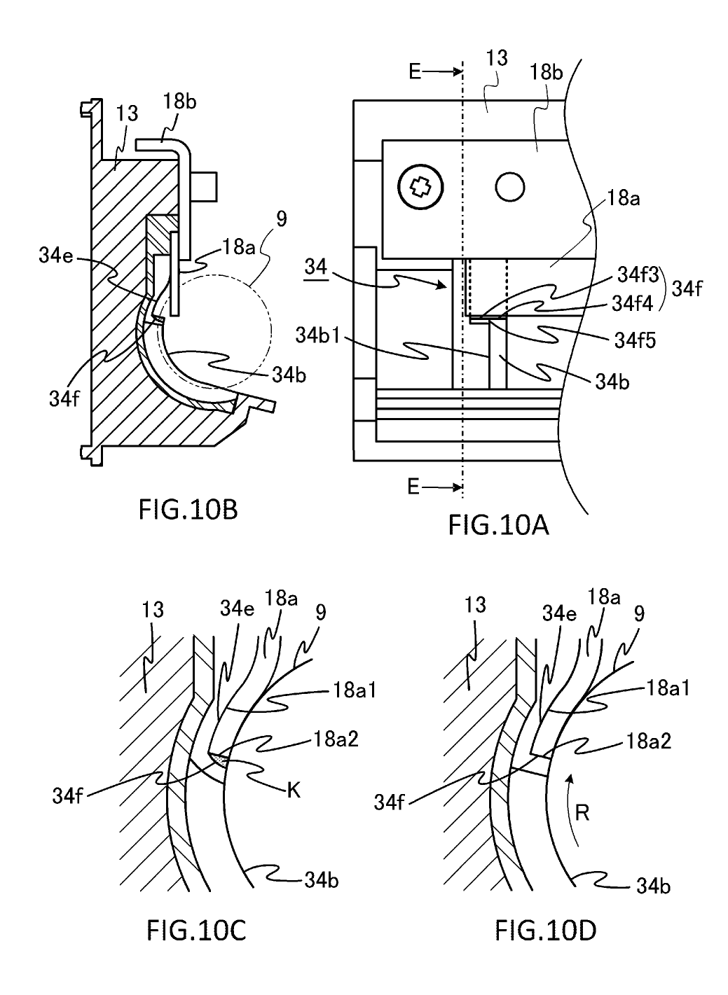

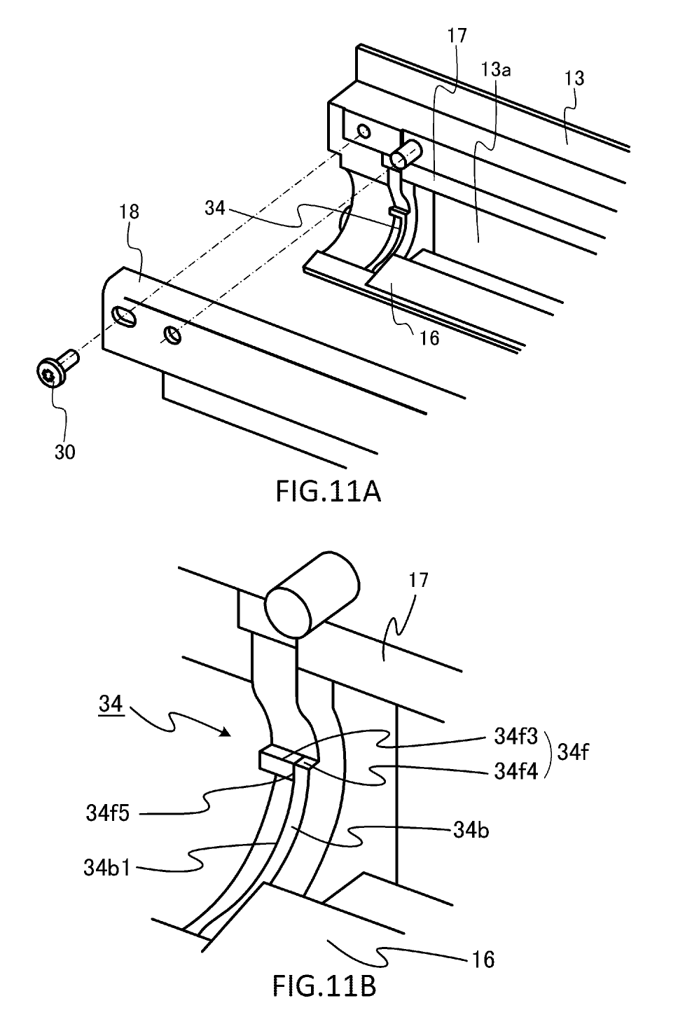

A configuration of a third embodiment of the present invention will now be described with reference to FIGS. 9A to 11B. FIGS. 9A to 9C are diagrams showing the seal member 24 shown in FIGS. 6A to 6C being replaced by a seal member 34 according to the present embodiment. In a similar manner, FIGS. 10A to 10D are diagrams showing the seal member 24 shown in FIGS. 7A to 7D being replaced by the seal member 34, and FIG. 11A is a diagram showing the seal member 24 shown in FIG. 8 being replaced by the seal member 34. In addition, FIG. 11B is a diagram showing an enlargement of a periphery of the seal member 34 shown in FIG. 11A. In the third embodiment, components in common with those of the first and second embodiments are assigned same reference characters and descriptions thereof will be omitted. Matters not described in the third embodiment are similar to those described in the first and second embodiments.

As shown in FIGS. 9A and 11B, the stepped portion 34f of the seal member 34 according to the present embodiment is divided by a division surface 34f5 in an in-plane direction of a side surface 34b1 of a rotating body contact portion 34b and includes a first stepped portion 34f3 and a second stepped portion 34f4. The first stepped portion 34f3 as a non-coupled portion is independent of the rotating body contact portion 34b, and the second stepped portion 34f4 as a coupled portion is integrated with the rotating body contact portion 34b as a first seal portion. The first stepped portion 34f3 and the second stepped portion 34f4 are in contact with each other in the axial direction of the developing roller 9 at the division surface 34f5 so as to be mutually slidably movable, and prevent leakage of the developer.

When the developing roller 9 is assembled, the blade 18a and the seal member 34 deform as shown in FIG. 10B. Accordingly, the rotating body contact portion 34b closely adheres to the developing roller 9 and the blade contact portion 34e closely adheres to the surface 18a1 that does not come into contact with the developing roller 9 of the blade 18a. In addition, a configuration is adopted in a similar manner to the first and second embodiments such that, as shown in FIG. 10C, a stepped gap K enclosed by the developing roller 9, the stepped portion 34f of the seal member 34, and the tip surface 18a2 of the blade 18a is created. The fact that seal performance is exhibited as the stepped portion 34f closely adheres to the tip surface 18a2 following rotation of the developing roller 9 is also similar to the first and second embodiments.

In the third embodiment, the stepped portion 34f is constituted by the first stepped portion 34f3 and the second stepped portion 34f4, and the first stepped portion 34f3 is capable of moving more flexibly than the second stepped portion 34f4. This is because, due to being independent of the rotating body contact portion 34b, the first stepped portion 34f3 more readily follows rotation of the developing roller 9. Accordingly, when the developing roller 9 rotates, the first stepped portion 34f3 and the tip surface 18a2 more readily closely adhere than the first and second embodiments. As a result, seal performance can be further improved.

Moreover, according to the present embodiment, contact pressure between the second stepped portion 34f4 and the tip surface 18a2 can be lowered as compared to the stepped portion 14f according to the first embodiment and the stepped portion 24f according to the second embodiment. This is because an improvement in seal performance achieved by the first stepped portion 34f3 enables seal performance at the second stepped portion 34f4 to be eased. Accordingly, at the second stepped portion 34f4, an occurrence of catching between the developing roller 9 and the developing blade 18 can be further suppressed. As described above, the seal member 34 can be made less susceptible to catching while further improving seal performance.

Moreover, while the stepped portion 34f according to the present embodiment is configured such that the first stepped portion 34f3 is arranged on an outer side in the axial direction of the developing roller 9 relative to the second stepped portion 34f4, the configuration of the stepped portion 34f is not limited thereto. The first stepped portion 34f3 may be arranged on an inner side in the axial direction of the developing roller 9 relative to the second stepped portion 34f4 or the first stepped portion 34f3 may be arranged on both sides of the second stepped portion 34f4 in the axial direction.

Configurations of the respective embodiments described above can be mutually combined to the greatest extent feasible. In addition, while the respective embodiments described above represent applications of the present invention in a seal member of a developing unit, configurations to which the present invention is applicable are not limited to the respective embodiments described above. For example, the present invention is also applicable to a seal configuration for preventing leakage of waste toner from a waste toner chamber of the drum frame body 20 in a cleaning unit or, in other words, to a seal member which is provided on the drum frame body 20 and which abuts or comes into sliding contact with the cleaning blade 10 or the photosensitive drum 5.

In addition, while only the seal configuration at one end among both ends in the axial direction of the developing roller 9 has been described in the description of the respective embodiments presented above, the other end has a similar seal configuration. Specifically, with respect to the seal configuration at the one end, the seal configuration at the other hand has a symmetrical (inverse) relationship in terms of an arrangement and a configuration in an axial direction and the like and is no different as far as functions and the like are concerned.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-014998, filed on Jan. 29, 2016, which is hereby incorporated by reference herein in its entirety.

What is claimed is:

1. A seal member formed of an elastic body and used in a unit or an image forming apparatus including a frame body which is provided with a housing portion for housing a developer, a rotating body which is provided in an opening of the housing portion of the frame body, and a blade which comes into contact with a surface of the rotating body,
the seal member being provided on the frame body in order to prevent the developer from leaking out from a gap among the frame body, the rotating body, and the blade in an end region of the opening in an axial direction of a rotary shaft of the rotating body, the seal member comprising:
a first seal portion which comes into contact with the rotating body;
a second seal portion which comes into contact with the blade; and
a third seal portion which is constituted by a surface formed in a stair shape and sequentially arranged between the first seal portion and the second seal portion and which causes a gap formed between the rotating body and the blade to decrease due to rotation of the rotating body.

2. The seal member according to claim 1, wherein in the third seal portion, a surface which comes into contact with the rotating body and the blade before assembly of the rotating body and the blade to the frame body is correspond to a surface which extends in a direction inclined with respect to a extending direction of an end surface, disposed in a tip portion of the blade, when the rotating body and the blade are assembled to the frame body.

3. The seal member according to claim 1, wherein
in the first seal portion, an first contact surface which comes into contact with the rotating body is an arc-shape, centered on the rotary shaft of the rotating body,
in the second seal portion, a second contact surface which comes into contact with the blade is an arc-shape, centered on the rotary shaft of the rotating body ,wherein a distance between the second contact surface and the rotary shaft is longer than a distance between the first contact surface and the rotary shaft, and
in the third seal portion, a third contact surface which comes into contact with the rotating body and the blade connects the first contact surface and the second contact surface to each other, wherein the third contact surface extends in a direction inclined with respect to a radial direction of an imaginary circle centered on the rotary shaft.

4. The seal member according to claim 1, wherein the third seal portion deforms so as to fill the gap as the rotating body rotates for the first time.

5. The seal member according to claim 1, wherein the third seal portion deforms so that a portion to be sandwiched between the rotating body and the blade is not created after the rotating body starts rotating for the first time.

6. A seal member formed of an elastic body and used in a unit or an image forming apparatus including a frame body which is provided with a housing portion for housing a developer, a rotating body which is provided in an opening of the housing portion of the frame body, and a blade which comes into contact with a surface of the rotating body,
the seal member being provided on the frame body in order to prevent the developer from leaking out from a gap among the frame body, the rotating body, and the blade in an end region of the opening in an axial direction of a rotary shaft of the rotating body, the seal member comprising:
a first seal portion which comes into contact with the rotating body;
a second seal portion which comes into contact with the blade; and
a third seal portion which comes into contact with (i) an end surface, disposed in a tip portion of the blade, with which the second contact portion does not come into contact and (ii) a region, disposed in a surface of the rotating body adjacent to the end surface, with which the first seal portion does not come into contact,
wherein the third seal portion is capable of assuming:
a first state where the third seal portion has a gap in relation to the rotating body and the blade, the gap being such that a distance between the third seal portion and the tip surface broadens gradually in a rotation direction of the rotating body towards the region on the surface of the rotating body; and
a second state where the gap has been narrowed or the gap has been filled.

7. The seal member according to claim 6, wherein the seal member is in the first state before the rotating body rotates for the first time, and the seal member assumes the second state when the rotating body rotates for the first time.

8. The seal member according to claim 1, wherein widths in the axial direction of the first seal portion, the second seal portion, and the third seal portion are the same.

9. The seal member according to claim 1, wherein a width of the third seal portion in the axial direction is wider than that of the first seal portion.

10. The seal member according to claim 9, wherein
the third seal portion includes:
a coupled portion which continues to the first seal portion in a circumferential direction of the rotating body; and
a non-coupled portion which does not continue to the first seal portion in the circumferential direction of the rotating body.

11. The seal member according to claim 10, wherein the coupled portion and the non-coupled portion are integrally continuous in the axial direction.

12. The seal member according to claim 10, wherein the coupled portion and the non-coupled portion are divided in the axial direction and are arranged so as to come into contact with each other in the axial direction.

13. The seal member according to claim 10, wherein the non-coupled portion is arranged on an outer side in the axial direction relative to the coupled portion.

14. The seal member according to claim 1, wherein the seal portion is an elastomer.

15. The seal member according to claim 1, wherein the blade is made of rubber.

16. A unit attachable to and detachable from an apparatus main body of an image forming apparatus, the unit comprising:
a frame body which is provided with a housing portion for housing a developer;
a rotating body which is provided in an opening of the housing portion of the frame body;
a blade which comes into contact with a surface of the rotating body; and
the seal member according to claim 1.

17. The unit according to claim 16, wherein the rotating body is a developer bearing member which bears a developer to be used in development of an electrostatic image formed on an image bearing member.

18. The unit according to claim 16, wherein the blade comes into contact with a surface of the rotating body so as to restrict an amount of the developer which is borne by the rotating body and which is carried outside through the opening.

19. An image forming apparatus, comprising:
a frame body which is provided with a housing portion for housing a developer;
a rotating body which is provided in an opening of the housing portion of the frame body;
a blade which comes into contact with a surface of the rotating body so as to restrict an amount of the developer, borne by the rotating body, which is carried outside through the opening; and
the seal member according to claim 1.
